(19) United States
(12) Patent Application Publication
(10) Pub. No.: US 2009/0029011 A1
(43) Pub. Date: Jan. 29, 2009

(54) CHEESE BLOCK DESIGN

(76) Inventors: Peter Robert Bond, Victoria (AU); Lyndon Christine Bond, Victoria (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/282,569

(22) PCT Filed: Mar. 9, 2007
(86) PCT No.: PCT/AU2007/000281

§ 371 Date: Sep. 11, 2008

(30) Foreign Application Priority Data
Mar. 13, 2006 (AU) 2006901253

(51) Int. Cl. A23C 19/00

(52) U.S. Cl. 426/76

(57) ABSTRACT

A cheese snack product comprising a block of cheese which has means to facilitate separation of the product into snack size portions. The means to facilitate separation may comprise areas of the block which are of lesser thickness than the remainder and these may be formed either by scoring or cutting into the surface of the block or by moulding the block to provide such portions. The block of the invention is preferably contained in a sealed package and a package which can be opened and then resealed is preferred. Also, it is possible to include in the package under the cheese a member which permits the cheese block to be readily moved outwardly from the package. The cheese block can comprise cheese of one or two or even more types so as to provide different flavours/textures for the product.

### TECHNICAL AREA

This invention relates to a cheese snack product. Cheese is recognised as a healthy dairy food and at the present time, while there is great concern about obesity which extends even to young children, it would be desirable to provide a cheese snack product which could be eaten in place of sweets and other junk food.

### BACKGROUND TO THE INVENTION

Cheese is manufactured to provide different cheeses of three or four general types which are processed cheese, soft cheeses such as caminbert, brie and cream cheese, and firm or hard cheese, firm cheese being cheddar or Gloucestor or others and hard cheeses are exemplified by parmesan and romano.

Processed cheese is the one which is generally eaten by children and it is normally packaged in blocks which may be 250-500 grams which blocks are located in an airtight packaging, usually of a plastics film material, or slices, which are individually packaged in a film material.

Neither of these forms are satisfactory for snack use as to obtain a piece of cheese from a block it is necessary to cut the cheese from the block and re-seal the block and slices, which are normally of the size of a sandwich bread loaf, whilst satisfactory for sandwiches, are in an unsatisfactory format for a snack.

There is sold in Australia one form of cheese which is used for snacks and this is a cheese stick manufactured by Kraft Food Ltd. which is a cylindrical sick of cheese in a plastic envelope which is designed so that the envelope is effectively removed and on most occasions the stick is eaten at the one time.

The other forms of cheese mentioned are sold in various types of containers but with fewer exceptions these containers will always hold at least 100 grams of cheese and often 500 or even 1 kg of cheese. With the exception of Bonbel cheeses none of these packages are satisfactory to enable the content to be used as a snack and Bonbel cheeses are packaged in the form of a wedge of cheese which is individually packaged in aluminium foil or the like and again, is not particularly adapted for use as a snack food.

### OUTLINE OF THE INVENTION

The object of the present invention is to provide a cheese snack product.

The invention includes a cheese snack product comprising of a block of cheese which has means to facilitate separation of the product into snack size portions.

The means to facilitate separation may comprise areas of the block which are of lesser thickness than the remainder and these may be formed either by scoring or cutting into the surface of the block or by moulding the block to provide such portions.

The block of the invention is preferably contained in a sealed package and a package which can be opened and then resealed is preferred.

Also, it is possible to include in the package under the cheese a member which permits the cheese block to be readily moved outwardly from the package.

The cheese block can comprise cheese of one or two or even more types.

### DESCRIPTION OF AN EMBODIMENT OF THE INVENTION

In order that the invention may be more readily understood, reference will be made to the accompanying drawings, in which:

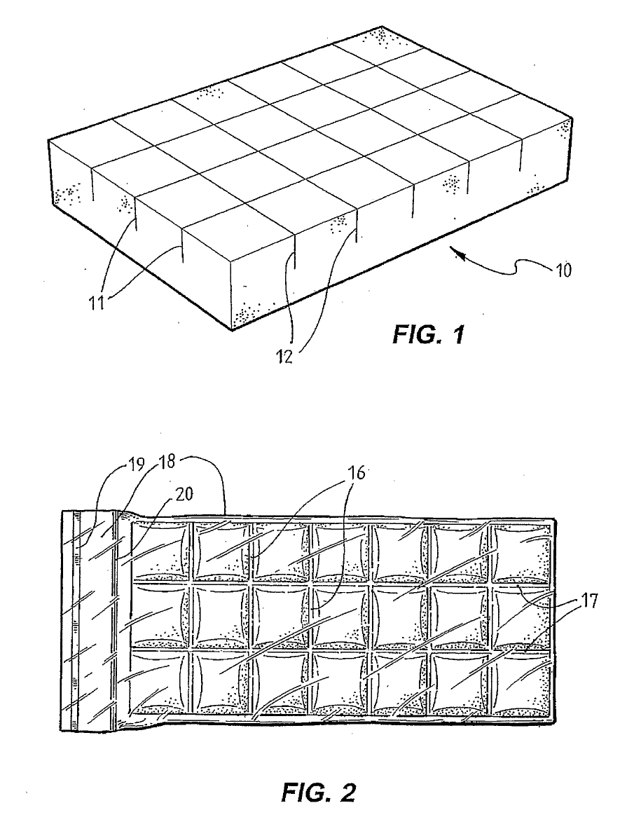

FIG. 1 is a perspective view of a first form of cheese snack product where the cheese concerned is a firm or hard cheese;

FIG. 2 is a plan view of a second form of cheese block which is of a processed, cheese and in this Fig. the block is encased in a plastic outer covering;

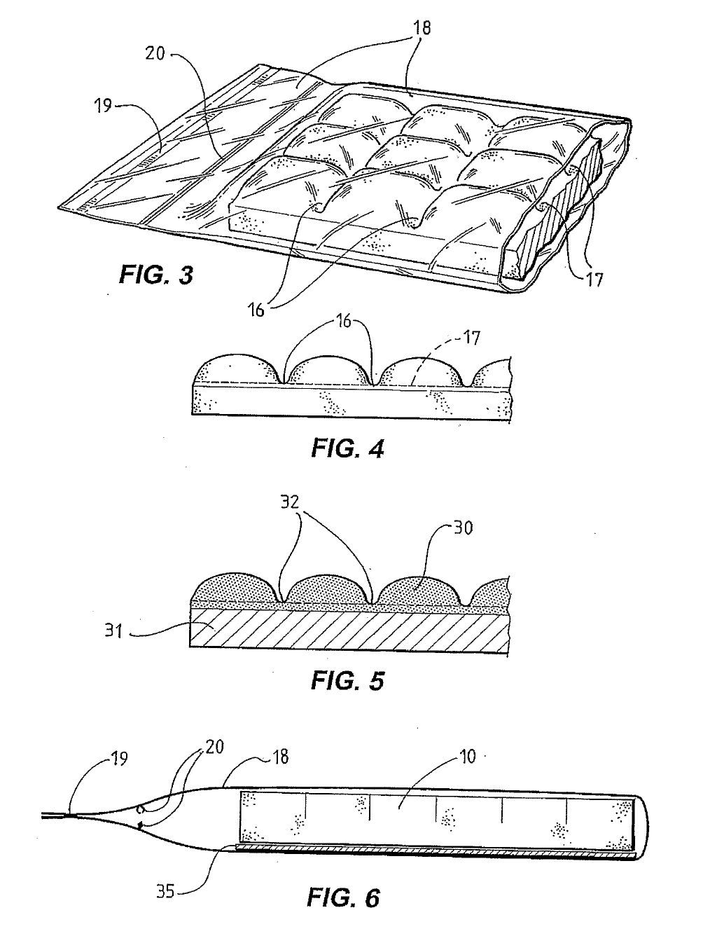

FIG. 3 is a perspective view of the block of FIG. 2 showing the formation of the snack size pieces;

FIG. 4 is a side elevation or view of the cheese block of FIG. 3;

FIG. 5 is a view similar to FIG. 4 of a block which would generally be as shown in FIG. 3 but using two different types of cheese; and

FIG. 6 shows a package including a block similar to that of FIG. 1 which is adapted to enable ready removal of the cheese from the package.

Referring first to FIG. 1 this would be applicable to a cheddar cheese or a cheese of a similar nature and cheeses which are somewhat softer, such as a Gruyer or Edam-type cheese or cheeses which are somewhat harder.

In this embodiment the cheese is formed as a rectangular block and the block may weigh between, say, 50 and 200 grams.

Whilst there is illustrated a rectangular block the block could be of any other required form and where shapes are referred to in the specification where the context permits the box can be of different shapes.

In this embodiment the block of cheese 10 is provided with a number of incisions, 11 running the length of the block, and 12 transversed to the block.

In this particular embodiment there are four portions running across the block, defined by three incisions and six portions running the length of the block defined by five incisions.

Where it is required to remove a portion or portions from the block it is only necessary to deform the block about the incisions and the portions will be removed.

Normally, the block would be broken about the first set of incisions 12 so some four portions would be delivered and these can then be separated into one or two portions for eating.

Whilst we have shown the incisions as simply been cuts through the cheese it is to be understood that the separation could be by other means, such as portions of the cheese being pressed inwardly to provide a thinner portion and if this is done then the edges may be somewhat curved rather than simply straight cuts as shown.

The finished product is packaged, normally in a plastic bag or the like and in one particular form, as illustrated in FIG. 6, the plastic bag may be provided with an outer seal 19 which may be associated with a zip closure or the like 20 inwardly thereof so that the outer portion can be removed and the bag resealed by use of the inner closure.

That is, it would normally only be necessary to remove the portion of the package adjacent the seal 20, slide the required quantity of cheese block from the open end of the package, break off the required portions, replace the block within the package and use the secondary seal to maintain the block air-tight.

The embodiment illustrated in FIG. 2 is a processed cheese which has been formed in a mould.

Processed cheeses are usually handled in a liquid form and can be extruded into blocks or moulded as suggested here.

The inner surface of the mould has incursions into the body thereof and in this form an attractive smooth surface block can be provided which has a number of longitudinal and transverse portions by means of which portions of the block can be removed. These formed portions are shown as 16 and 17 in the figure.

As the moulds can be polished cheese blocks formed in this way can have an extremely smooth and shiny surface.

In the embodiment the block is shown in a plastic sleeve or the like 18 which can be provided with an outer, permanent seal 19 and an inner seal 20 which can be opened and closed, being a seal of a zip-lock type known in these types of containers.

FIG. 3 is a perspective view of the block of FIG. 2 so the formation of the block can be understood. FIG. 4 is a side elevation of the block to show the formation.

Harder cheeses can also be formed in this way by using forms into which the curd is pressed after cutting, heating and stirred.

FIG. 5 shows a different form of product where the upper portion 30 may be of a different cheese type to the lower portion 31.

Particularly as far as processed cheeses are concerned it is readily possible to form these of different flavours such as a smoked flavour or a chive flavour or the like and in this embodiment the processed cheese being passed into the mould is so flavoured.

Once this has been placed into the mould either a plain, or even different flavoured processed cheese, can be poured over the top of the mould at 31 and as the two cheeses would be basically liquid at the time they would cohere closely together.

Instead of layer 31 being processed cheese it could be a harder cheese such as a cheddar which could be formed into slices the size of the block and be placed over the cheese 30 while it is still in the liquid or semi-liquid state, so it would effectively become glued to the slice.

In this embodiment the processed cheese at the top is formed with thinner portions and these are sufficient in relation to the thickness of the slice of the cheddar or like cheese to permit the block to be separated along the narrower portions 32 of the processed cheese.

Instead of processed cheese being used as the cheese 30 it is possible to use other forms of cheese; for example, a cream cheese could be placed into the mould and smoothed down to provide the upper portion of the cheese and then another form of cheese, which could, for example, be a processed cheese or a cheddar or some other cheese, is then located there-over and the two portions can be connected together either by a fusion or even by the use of an edible gum or the like.

In this form of cheese it will be appreciated that not only the flavours of the two parts of the cheese, but also the textures can be different to provide an unusual and different type of snack food.

Because cheese can well have a relatively high coefficient to friction when against a plastics material the embodiment of FIG. 6 which shows a cheese of the type 10 of FIG. 1 is located on a slide member or the like 35 which can be effectively the same size as the block 10 and this is located beneath the block in the package.

In this form, as previously mentioned, there is a permanent seal 19 which is removed when the cheese is to be used and thereby open the end of the package.

In this embodiment the slide 35 permits the cheese to readily be moved outwardly from the package, the required portions can be broken off and the cheese and the slide moved back into the package and the reclosable seal 20 sealed to keep the cheese fresh.

Whilst there has been described herewith certain embodiments of the invention, these are only exemplary, both inasfar in which the blocks are formed, the way the blocks are connected together, if there are to be two different types of cheese, the shapes of the blocks and the thinner portions and the actual form of packaging can all be modified and varied.

1. A cheese snack product comprising a block of cheese which has means to facilitate separation of the product into snack sized portions.

2. A cheese snack product as claimed in claim 1 wherein the means to facilitate the separation of the product are provided by the formation of areas of the product which are thinner than the remainder of the product.

3. A cheese snack product as claimed in claim 2 wherein the cheese is a firm cheese and wherein the thinner portions are provided by incisions into the surface of the product.

4. A cheese snack product as claimed in claim 2 wherein the cheese is a processed cheese and wherein the snack product is formed in a mould, the mould being formed that when the product is moulded, the product has thinner and deeper portions whereby the product can be separated along the thinner portions.

5. A cheese snack product as claimed in claim 1 wherein the product includes at least two types of cheese, one layered above the other.

6. A cheese snack product as claimed in claim 5 wherein the upper layer is a soft cheese which is formed into defined portions and wherein the other layer is a firmer cheese having means whereby it can be separated, together with the said upper layer into snack sized portions.

7. A cheese snack product as claimed in claim 6 wherein the said one layer is formed in a mould and wherein the other layer is located over the said one layer before the cheese has firmed thereby causing a bond between the two layers.

8. A cheese snack product as claimed in claim 1 wherein the product is packed into a package from which portions can be removed.

9. A cheese snack product as claimed in claim 8 wherein the product is placed on a member of effectively the same size as the product whereby the product can readily be partially or wholly removed from the packaging to enable portions of the product to be obtained.
